(19) United States
(12) Patent Application Publication
(10) Pub. No.: US 2025/0279895 A1
(43) Pub. Date: Sep. 4, 2025

(54) Detecting Copyright Infringement Using Sequence-Based Hashes

(71) Applicant: XYCORP LTD., Malibu, CA (US)

(72) Inventors: Lamara De Brouwer, Malibu, CA (US); Walter De Brouwer, Malibu, CA (US); Geert Trooskens, Meise (BE); Vincent Wing, Orange, CA (US)

(73) Assignee: XYCORP LTD., Malibu, CA (US)

(21) Appl. No.: 18/595,309

(22) Filed: Mar. 4, 2024

(51) Int. Cl. H04L 9/32; G10H 1/00

(52) U.S. Cl. CPC H04L 9/3236; G10H 1/0008; H04L 2209/605

(57) ABSTRACT

In some aspects, a server receives a new song comprised of multiple tracks, creates a first set of hashes based on the multiple tracks, and selects data associated with a copyrighted song in a database. The data includes a second set of hashes associated with the copyrighted song. The server performs a comparison of a first subset of the first set of hashes to a second subset of the second set of hashes and determines, based on the comparison, a similarity index. The server indicates a similarity between the new song and the copyrighted song based on the similarity index. The server may receive a selection to modify the new song to reduce the similarity between the new song and the copyrighted song and modify the new song to reduce the similarity between the new song and the copyrighted song.

### BACKGROUND OF THE INVENTION

### Field of the Invention

This invention relates generally to systems and techniques to determine whether a particular song infringes on one or more copyrighted songs.

### Description of the Related Art

The creation of a musical composition is bound by the finite nature of musical elements that can be articulated. Notation enables the application of expressive nuances to musical notes, yet the scope of composition is confined to the octave range, limiting the permutations of musical notes within a given measure or piece. This results in numerous compositions that, despite their stylistic differences, may share a similarity in their foundational musical structure.

### SUMMARY OF THE INVENTION

This Summary provides a simplified form of concepts that are further described below in the Detailed Description. This Summary is not intended to identify key or essential features and should therefore not be used for determining or limiting the scope of the claimed subject matter.

In some aspects, a server receives a new song comprised of multiple tracks, creates a first set of hashes based on the multiple tracks, and selects data associated with a copyrighted song in a database. The data includes a second set of hashes associated with the copyrighted song. The server performs a comparison of a first subset of the first set of hashes to a second subset of the second set of hashes and determines, based on the comparison, a similarity index. The server indicates a similarity between the new song and the copyrighted song based on the similarity index. The server may receive a selection to modify the new song to reduce the similarity between the new song and the copyrighted song and modify the new song to reduce the similarity between the new song and the copyrighted song.

### BRIEF DESCRIPTION OF THE DRAWINGS

A more complete understanding of the present disclosure may be obtained by reference to the following Detailed Description when taken in conjunction with the accompanying Drawings. In the figures, the left-most digit(s) of a reference number identifies the figure in which the reference number first appears. The same reference numbers in different figures indicate similar or identical items.

FIG. 1 is a block diagram of a system to determine whether a particular song infringes on one or more copyrighted songs, according to some embodiments.

FIG. 2 is a block diagram illustrating creating hashes of note sequences in individual tracks of a song, according to some embodiments.

FIG. 3 is a block diagram illustrating using a subset (sample) from two sets to determine similarities, according to some embodiments.

FIG. 4 is a flowchart of a process to create a table of data associated with copyrighted songs, according to some embodiments.

FIG. 5 is a flowchart of a process that includes detecting similarities between a new song and a copyrighted song, according to some embodiments.

FIG. 6 is a flowchart of a process to train (or retrain) a machine learning algorithm to create an artificial intelligence, according to some embodiments.

FIG. 7 illustrates an example configuration of a computing device that can be used to implement the systems and techniques described herein.

### DETAILED DESCRIPTION

The systems and techniques described herein enable a newly created song (“new song”) to be compared with copyrighted songs to determine if the new song includes a sequence of notes that is similar (e.g., in a different key) or identical to one or more of the copyrighted songs. The systems and techniques enable a user to modify the new song to reduce the similarity. For example, the systems and techniques may enable a user to modify a track by adding notes to or subtracting notes from the similar or identical track to reduce the similarity. While the examples herein describe using a generative artificial intelligence (AI) to generate the new song, the systems and techniques can be applied to new songs created by one or more humans with or without the assistance of AI. Many modern digital audio workstations (DAWs) incorporate AI to enable, for example, a user to quickly generate one or more backing tracks (e.g., drums, bass, guitar, keyboards, or any combination thereof). The systems and techniques described herein may be used to determine potential copyright infringement regardless of whether AI is used or not used in the creation of the new song and regardless of what percentage (e.g., 0% to 100%) of the song was created using AI.

A database of copyrighted songs may be indexed using musical k-mers. Each musical k-mer is defined as a sequence of k (typically k>=8) consecutive musical notes. The systems and techniques use k-mers as fundamental units when performing an analysis of music. Typically, a single piece of music encompasses hundreds to thousands of notes across various instruments, leading to the aggregation of millions of k-mers within a comprehensive index of an extensive music collection. Consequently, the computational demands for processing k-mer data are substantial. To mitigate these challenges, the systems and techniques use an indexing data structure that leverages a hash table that is optimized for the efficient retrieval of keys corresponding to short musical sequences.

One technique to determine copyright infringement is to look at a first sequence of eight consecutive notes in a song and determine whether the sequence is similar to a second sequence of eight consecutive notes in a copyrighted song. In some cases, the similarity determination may take into account alterations in musical key. For example, when a sequence of eight notes played in (transposed to) a different key, the original sequence and the transposed sequence are identical, except for the change in key. Musicians frequently take a melodic sequence and transpose it in the same song. For example, in pop music, a 1-4-5 chord progression (sometimes written as I-IV-V) is a song section that uses chords derived from the first, fourth, and fifth notes of the Major scale. To illustrate, chord progressions C Major, F Major, and G Major are often used in many hits. These 3 chords can, of course, be transposed to other keys. The systems and techniques are able to detect that two sequences of notes are similar even when the two sequences of notes are in different keys.

For each 8-mer of subsequent notes in each melodic track of the song, an index ρ (key-independent index) is calculated as follows:

$$ρ = {\sum }_{i = 1}^{7} ( {n}_{i} - {n}_{0} ) {12}^{i - 1}$$

where i goes from 1 to 7 to examine 8 consecutive notes (k-mer where k=8) and n is one of the notes in a sequence. To take into account key variations within a song, the scale is standardized relative to the initial note. For example, C, F, G may be standardized to I, IV, V. Of course, any type of standardization using a 12 note scale may be used. The same principles may be applied to additional scales that use more than 12 notes, such as scales with 18, 20, 22, or 24 notes. For example, some East Indian ragas may use up to 22 notes while some Turkish scales use 24 quarter notes.

A song's digital representation (e.g., Musical Instrument Digital Interface (MIDI) or another similar digital representation) is created. Each song includes multiple tracks, e.g., bass, guitar, keyboards, drums, lead vocals, and the like. In most cases, tracks of instruments are analyzed to determine their similarity to copyrighted songs. This means that, in most cases, the drum track(s) (including percussion) and vocal track(s) (e.g., lead vocals, backing vocals, and the like) may be excluded from the analysis. Each instrument track includes a series of notes that form their respective melodies. Using a sliding window (shingling), a unique hash is generated for each k-mer (k consecutive note) sequence. A linking table is created to store the associations between the index, the instrument track, positional data (e.g., a location in the song where a particular note sequence occurs), and the song. The location may be specified in one or more ways, including for example, a time code, such as Society of Motion Picture and Television Engineers (SMPTE) time code, or the like.

After creating hashes for consecutive notes (k-mers) of a song being analyzed, the systems and techniques may perform a search for the hashes in a table of known hashes associated with copyrighted songs. The search may be a strict search or a relative search. In a strict search, a determination is made whether each note in the search sequence (of the song being analyzed) exactly matches a corresponding note in the target (copyrighted song). For a successful match, the note sequence in the song being analyzed and the copyrighted song must share an identical pitch and octave. Thus, in strict searching, the pitch of a note must be identical for a match to occur. However, musicians often transpose the key of a musical piece to facilitate ease of performance (e.g., to bring the notes into a range that can be played by a particular instrument or sung by a singer). For example, many instruments have a limited number of notes that they can play and vocalists may have a limited vocal range and transposing a piece of music enables the instrument or vocalist to reproduce all the notes in a piece of music. Transposing means altering the pitches of the notes within a sequence, without altering their relative positions of the notes relative to one another. By modifying the song being analyzed into a standardized format in which the relationships between notes in a sequence are preserved, the intervals between the notes remain consistent, regardless of the specific pitch of each note or the song's key. Thus, performing a relative search, based on the relative relationships between notes in a note sequence allows for the identification of matching sequences, even when the note sequence has been transposed to a different key.

Assume two musical sequences X and Y having a same sequence length n. For a given k, the occurrence of all possible k-mer melodies, as denoted by w=w1w2^{. . .}wk, is counted for the sequence X and recorded in a k-mer frequency vector Xw. Similarly, the k-mer melodies are counted and recorded for the sequence Y in Yw. In this example, both Xw and Yw are 12 k dimensional vectors made up of the occurrence numbers of all possible 12-mers of the 12 notes, which is denoted by Λk. Therefore, the similarity between the two sequences can be measured by correlating the two k-mer frequency vectors Xw and Yw. This similarity metric can also be transformed to obtain dissimilarity (distance) metrics. A similarity metric D2 statistic may be defined as:

$${D}_{2} = {\sum }_{w ∈ {A}^{k}} {X}_{w} {Y}_{w}$$

However, determining similarity metric D2 may be computationally expensive. Therefore, to reduce the use of computational resources, the systems and techniques use the following approach. A hashing algorithm J, such as the MinHash algorithm (e.g., min-wise independent permutations locality sensitive hashing scheme) or similar algorithm, may be used to rapidly estimate a similarity between two sets A and B:

$$J ( A , B ) = \frac{\vert A ⋂ B \vert}{\vert A ⋃ B \vert} \approx \frac{\vert S ( A ⋃ B ) ⋂ S ( A ) ⋂ S ( B ) \vert}{\vert S ( A ⋃ B ) \vert}$$

A hashing algorithm, such as MinHash or similar, offers an efficient approach for estimating a similarity measure, such as a Jaccard similarity index (or similar), between two sets of note sequences. Initially, the sequences of two songs are dissected into their k-mer constituents. Subsequently, each k-mer undergoes transformation via a hash function h, yielding a hash output (either a 32-bit or 64-bit) based on the size of the input k-mer, resulting in two sets of hash values, A and B, each comprising |A| and |B| distinct hash values. The Jaccard index (or another similar similarity measure) is determined, e.g., a proportion of (1) an intersection of hashes of A and B (A∩B) relative to (2) the total number (union) of unique hashes present in both A and B (A∪B). To reduce the computational intensity of such a calculation, the hashing (e.g., MinHash) algorithm uses an approximation of each set by selecting a smaller, random subset of A and B. This process involves the creation of MinHash subsets S(A) and S(B), each of a particular size s (s>1). For example, when s=5, the five minimal hash values from sets A and B, respectively, may be used. The use of S(A) and S(B) enables the derivation of the s minimal hash values across the combined set A∪B, denoted as S(A∪B). Because S(A∪B) represents a random subset of A∪B, the ratio of shared elements between S(A) and S(B) within this subset serves as an unbiased estimator for the Jaccard similarity index J(A,B), thereby providing a computationally efficient and effective means of estimating set similarity. Of course, other measures of similarity besides Jaccard similarity, such as, for example, a simple matching coefficient, a Hamming distance, a Sorensen-Dice coefficient, a Tversky index, or a Tanimoto distance, or other similarity measurement may be used.

Any similarity coefficient that indicates the similarity between two sets may be used. For example, if A is a first set and B is a second set, then the Jaccard index J (similarity) of A to B is defined as the ratio of (1) the number of elements of their intersection (A∩B) to (2) the number of elements of their union (A∪B):

$$J ( A , B ) = \frac{\vert A ⋂ B \vert}{\vert A ⋃ B \vert} .$$

The Jaccard similarity index is 0 when the two sets A and B are completely disjoint, 1 when the two sets are identical, and between 0 and 1 when there is similarity between the two sets. Two sets are more similar (e.g., have relatively more members in common) when their Jaccard index is closer to 1. The hashing algorithm (e.g., MinHash) is used to quickly estimate J(A,B), without explicitly computing the intersection and union. In this way, the systems and techniques enable the comparison of a song to copyrighted songs in near real time, resulting in the detection of potential copyright infringement matches in less than 3 seconds.

As a first example, a method includes receiving, by one or more processors, a new song comprised of multiple tracks. The method may include generating, by a generative artificial intelligence, at least one track of the multiple tracks of the new song. The method includes creating, by the one or more processors, a first set of hashes based on the multiple tracks. For example, creating the first set of hashes based on the multiple tracks may include: deconstructing the new song into the multiple tracks, selecting a particular track of the multiple tracks, and creating, for the particular track of the multiple tracks, a hash for individual consecutive note sequences (k-mers) included in the particular track. The individual consecutive note sequences included in the particular track include at least 8 consecutive notes. The method includes selecting, by the one or more processors, data associated with a copyrighted song in a database. The data includes a second set of hashes associated with the copyrighted song. The method includes performing a comparison, by the one or more processors, of a first subset of the first set of hashes to a second subset of the second set of hashes. For example, performing a comparison of a first subset of the first set of hashes to a second subset of the second set of hashes may include: determining an intersection of the first subset of the first set of hashes and the second subset of the second set of hashes, determining a union of the first subset of the first set of hashes and the second subset of the second set of hashes, and determining a ratio of the intersection to the union. The method includes determining, by the one or more processors and based on the comparison, a similarity index. For example, the similarity index may be a Jaccard index. The method includes indicating, by the one or more processors, a similarity between the new song and the copyrighted song based on the similarity index. The method includes receiving, by the one or more processors, a selection to modify the new song to reduce the similarity between the new song and the copyrighted song. The method includes modifying, by the one or more processors, the new song to reduce the similarity between the new song and the copyrighted song.

As a second example, a server includes: one or more processors and a non-transitory memory device to store instructions executable by the one or more processors to perform various operations. The operations include receiving a new song comprised of multiple tracks. In some cases, a generative artificial intelligence may generate each track of the multiple tracks of the new song. The operation include creating a first set of hashes based on the multiple tracks. For example, creating the first set of hashes based on the multiple tracks may include: deconstructing the new song into the multiple tracks, selecting a particular track of the multiple tracks, and creating, for the particular track of the multiple tracks, a hash for individual note sequences included in the particular track. The individual note sequences include at least 8 consecutive notes. The operations include selecting data associated with a copyrighted song in a database. The data includes a second set of hashes associated with the copyrighted song. The operations include performing a comparison of a first subset of the first set of hashes to a second subset of the second set of hashes. For example, performing the comparison of the first subset of the first set of hashes to the second subset of the second set of hashes may include: determining an intersection of the first subset of the first set of hashes and the second subset of the second set of hashes, determining a union of the first subset of the first set of hashes and the second subset of the second set of hashes, and determining a ratio of the intersection to the union. The operations include determining, based on the comparison, a similarity index, such as, for example, a Jaccard index or similar. The operations include indicating a similarity between the new song and the copyrighted song based on the similarity index. The operations include receiving a selection to modify the new song to reduce the similarity between the new song and the copyrighted song. The operations include modifying the new song to reduce the similarity between the new song and the copyrighted song. For example, modifying the new song to reduce the similarity between the new song and the copyrighted song may include: determining that a particular track of the multiple tracks of the new song is similar to a copyrighted track of the copyrighted song, and automatically modifying one or more note sequences in the particular track. The modifying may include: adding one or more notes in the particular track, deleting one or more notes in the particular track, modifying a pitch of one or more notes in the particular track, modifying a duration of one or more notes in the particular track, or any combination thereof. As a second example, modifying the new song to reduce the similarity between the new song and the copyrighted song may include: determining that a particular track of the multiple tracks of the new song is similar to a copyrighted track of the copyrighted song and instructing a generative artificial intelligence to generate a new track to replace the particular track.

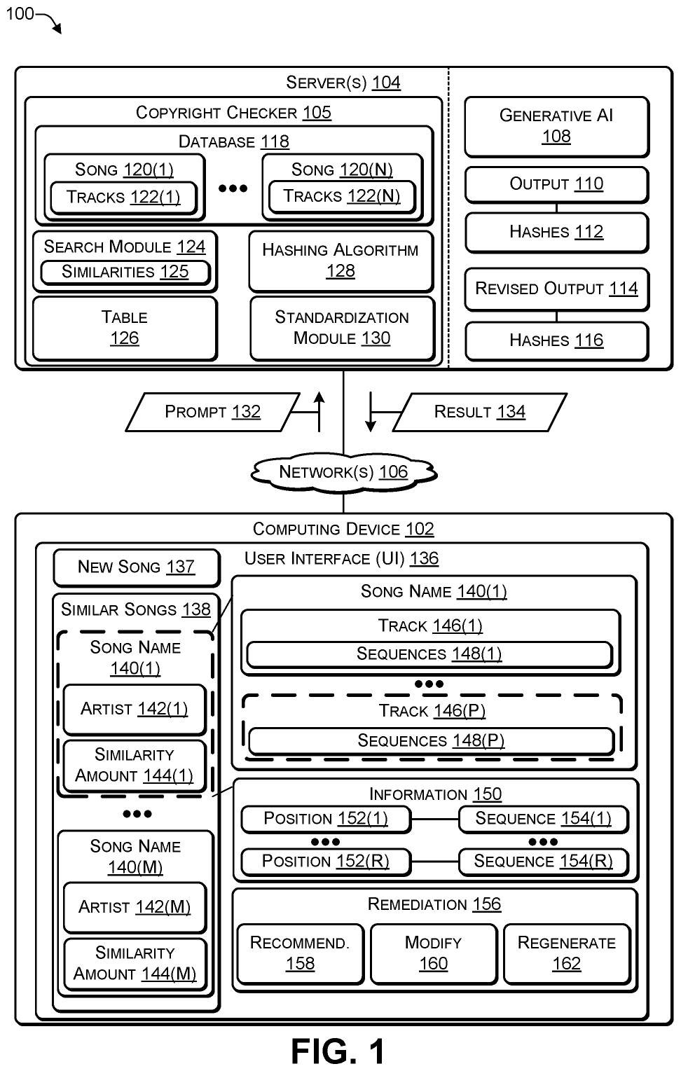

FIG. 1 is a block diagram of a system 100 to determine whether a particular song infringes on one or more copyrighted songs, according to some embodiments. The system 100 includes a computing device 102 connected to one or more servers 104 via one or more networks 106.

The servers 104 may host a copyright checker 105 and a generative AI 108 to generate output 110 that includes music. Typically, the copyright checker 105 may be hosted by a first set of one or more of the servers 104 and the generative AI 108 may be hosted by a second set of one or more of the servers 104. The output 110 may include MIDI data, audio data (e.g., wave files), other types of music related data, or any combination thereof. The output 110 may include multiple tracks, with each track corresponding to notes played by a particular instrument (e.g., guitar, bass, keyboard, saxophone, trumpet, or another type of instrument). A hashing algorithm 128 may create multiple hashes of note sequences (k-mers) included in the output 110. In some cases, e.g., if the output 110 is found to potentially infringe on one or more copyrighted songs, the generative AI 108 may create revised output 114. The revised output 114 may include one or more tracks that are different from the tracks included in the output 110. The hashing algorithm 128 may create the hashes 116 based on note sequences (k-mers) included in the tracks of the revised output 114.

The copyright checker 105 may uses a database 118 that includes data associated with multiple copyrighted songs 120(1) to 120(N) (N>100,000). The data may include MIDI data associated with each song 120, metadata (e.g., artist name, album name, song name, genre, year released, and the like), and other related data. Each of the songs 120 may be broken down into multiple tracks, with the song 120(1) including tracks 122(1) and song 120(N) including tracks 122(N). Each track may include MIDI data and metadata. A search module 124 may perform a comparison of the hashes 112 (or 116) with hashes of the songs 120 stored in a table 126 to determine whether the output 110 (or the revised output 114) include similarities 125 to one or more tracks 122 of the songs 120. For example, the table 126 may include hashes of note sequences (k-mers) in the tracks 122. A standardization module 130 may standardize the note sequences (k-mers) of the tracks 122, the output 110, and the revised output 114 by converting each note sequence into a standardized format that preserves the relationship among the notes (e.g., a second note is Q notes away from a first note, Q>=0.5). In this way, a sequence of notes in a first key, when standardized, is identical to the sequence of notes in a second key.

The server 104 may receive a prompt 132 instructing the generative AI 108 to generate a result 134 that includes the output 110 (or the revised output 114). For example, the result 134 may include a new song 137. The result 134 may include data identifying similarities between the output 110 (or the revised output 114) and one or more of the tracks 122 of the songs 120. The data identifying the similarities may be displayed by the computing device 102 using a user interface 136.

The computing device 102 may receive the results 134 that include the new song 137 and the similarities 125 between the output 110 (or the revised output 114) and the tracks 122 of the songs 120. The UI 136 may display similar songs 138 that are similar to the new song 137. The similar songs 138 may include one or more songs that are identified with a song name 140(1) to a song name 140(M) (M>0). Each of the filenames 140 may identify an artist 142 associated with the song name 140 and a similarity amount 144. The similarity amount 144 may be a similarity measurement, such as a Jaccard similarity index (or other similarity measure), expressed as a numeric quantity, such as a number from 0 to 1, a percentage (e.g., from 0% to 100%), or another numeric quantity. The computing device 102 may order the similar songs 138 in a particular order based on the similarity amount 144, such as from highest (e.g., most similar) to lowest (e.g., least similar). For example, song name 140(1) may be the most similar to the output 110 (or the revised output 114) while song name 140(M) may be the least similar to the output 110 (or the revised output 114). In some cases, the computing device 102 may filter out and not display the song names 140 of songs having a similarity amount 144 that is less than a threshold amount, such as less than 0.5 or 50% similarity. The threshold amount may be a default value that can be changed by a user of the computing device 102.

In FIG. 1, the dashed lines indicate user selected items. For example, in FIG. 1, song name 140(1) in the similar songs 138 is selected and is thus illustrated with dashed lines. In response to a user selecting a particular song name 140 in the similar songs 138, the UI 136 may display additional details associated with the selected song, such as the song name 140(1) and the instrument tracks 146(1) to 146(P) (P>0) included in the song with the song name 140(1). For each of the tracks 146, the UI 136 may display one or more sequences 148 that were found to be similar to a note sequence in the output 110 (or in the revised output 114). When the user selects one of the tracks 146, such as a track 146(P), the UI 136 may display additional information 150 about the selected track, such as a position 152(1) to 15(R) (R>0) associated with similar sequences 154(1) to 154(R), respectively, in the selected track. The position 152 may be expressed as a time code (e.g., SMPTE time code), or another measurement to indicate a position of each sequence 154 in the track 146.

The UI 136 may display one or more options to perform remediation 156 of the selected track 146 or the similar sequence 154 in the selected track 146. The remediation 156 may include a recommendation 158, an option to modify 160, and an option to regenerate 162. The modify option 116 may enable the user to edit the sequence of notes in the new song 137 that are similar to one of the similar songs 138 by deleting notes, adding notes, modifying (e.g., changing the pitch and/or duration of) existing notes, or any combination thereof. The regenerate option 162 may cause the generative AI 108 to regenerate a track in the new song 137 that is similar to selected track 146(P) or to regenerate one or more of the note sequences in the new song 137.

While the copyright checker 105 is illustrated in FIG. 1 as determining whether the new song 137 has copyright issues, the copyright checker 105 may also be used for user generated content including content in which a portion of the new song 137 is created by the generative AI 108. For example, a user may use a digital audio workstation (DAW) to create new song 137 with multiple tracks and use the copyright checker 105 to determine whether any portions of the new song 137 have copyright issues (e.g., potentially infringe on the copyrighted songs 120). As another example, the user may use a DAW to create multiple tracks and use the generative AI 108 to generate one or more tracks for the new song 137. To illustrate, the user may create a bass track, a drum track, and record a vocal track and prompt the generative AI 108 to create a backing keyboard track. In this way, a portion of the new song 137 is user created and a remaining portion of the song is AI generated The copyright checker 105 can check whether any of the tracks, user created and AI generated, in the new song 137 have potential copyright issues.

Thus, a server (or cloud) based copyright checker may be used to determine whether a newly create song potentially infringes on one or more copyrighted songs. The song may be newly created by a user, by a generative AI, or by a combination of both. The copyright checker analyzes the song in terms of tracks of note sequences (e.g., MIDI data). The copyright checker provides suggestions to remediate the potential copyright infringement to reduce the similarity between one or more tracks of the song and tracks of the copyrighted songs. Remediation may include editing or regenerating the similar track(s) or portions thereof. In some cases, the copyright checker may be used with a generative AI that is used to generate a song (or portions thereof). The generative AI may use a large language model (LLM) or another type of generative AI that is trained using a database of copyrighted music. The copyright checker may use a database of over 200,000 MIDI songs. K-mers, where k>7, (k consecutive notes) are analyzed for each track. Typically, a song may have between 5 and 20 instrument tracks. The note phrases (k-mers) are standardized based on the first note to make the sequences independent of the key being used. A hash of each k-mer (e.g., k consecutive note phrase) may be used as the index. The hash may be stored with metadata that indicates to which song the hash belongs, position (timecode) in the song, the type of instrument (e.g., bass, guitar, keyboards, or the like), and so on. After all the copyrighted songs have been indexed, the copyright checker may be used to identify which parts of a song are similar to copyrighted songs in training data. The copyrighted songs used to train the generative AI may also be the copyrighted songs that the copyright checker uses to compare the newly created song against. Copyright infringement requires a minimum of 8 consecutive notes to match which is why the copyright checker uses k-mers of 8 notes in length. Of course, a user may specify that the copyright checker 105 use longer k-mers, such as 10, 12, or more consecutive notes. The user interface of the copyright checker shows which songs are similar, which tracks in the songs are similar, and the locations (e.g., timecode) of the similar consecutive note sequences. The user interface also provides actionable remediation selections to regenerate the instrument track that infringes to make it non-infringing.

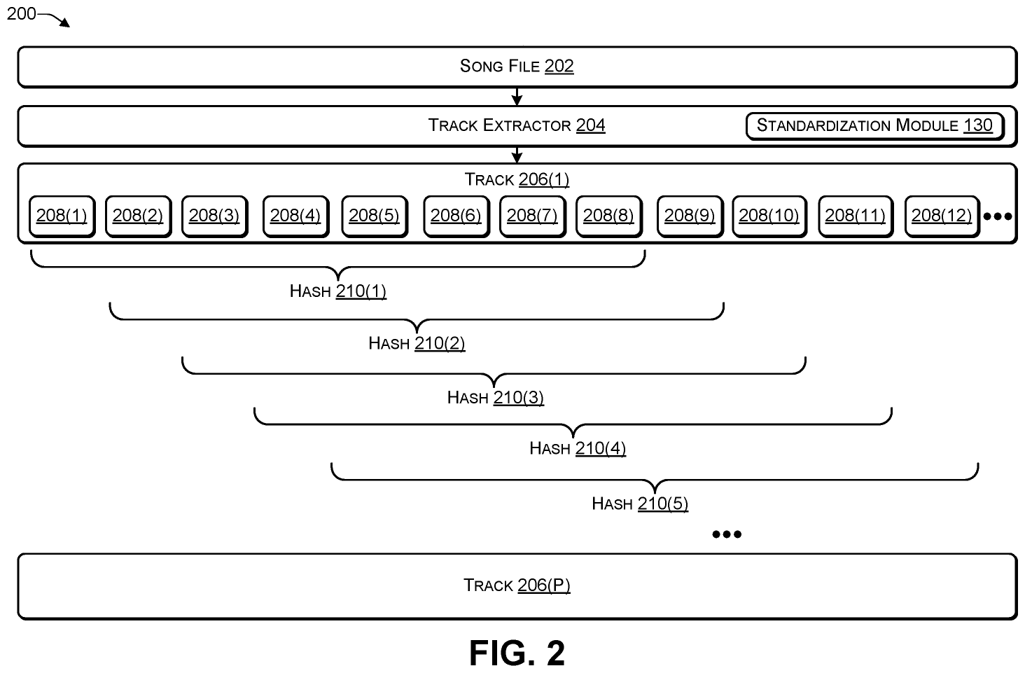

FIG. 2 is a block diagram 200 illustrating creating hashes of note sequences in individual tracks of a song, according to some embodiments. A song file 202 is received by a track extractor 204. The song file 202 may be one of the songs 120 included in the database 118. The track extractor 204 may extract multiple tracks 206(1) to 206(P) (P>0, P typically between about 5 to 20). The standardization module 130 may standardize the notes in each track such that the relationship between the notes is maintained while the key in which the notes are played is disregarded. In some cases, the song file 202 may include MIDI data. In other cases the song file 202 may include audio data and the track extractor 204 may extract multiple MIDI tracks 206 using artificial intelligence.

Each of the tracks 206 include a sequence of notes, such as 208(1) to 208(12) and beyond. A sliding window is used to select multiple k-mers (note sequences) and a hash 210 is calculated for each k-mer. In FIG. 2, k=8 so 8-mers are used to create each hash 210. For example, notes 208(1) to 208(8) are used to create hash 210(1), notes 208(2) to 208(9) are used to create hash 210(2), notes 208(3) to 208(10) are used to create hash 210(3), notes 208(4) to 208(11) are used to create hash 210(4), notes 208(5) to 208(12) are used to create hash 210(5), and so on.

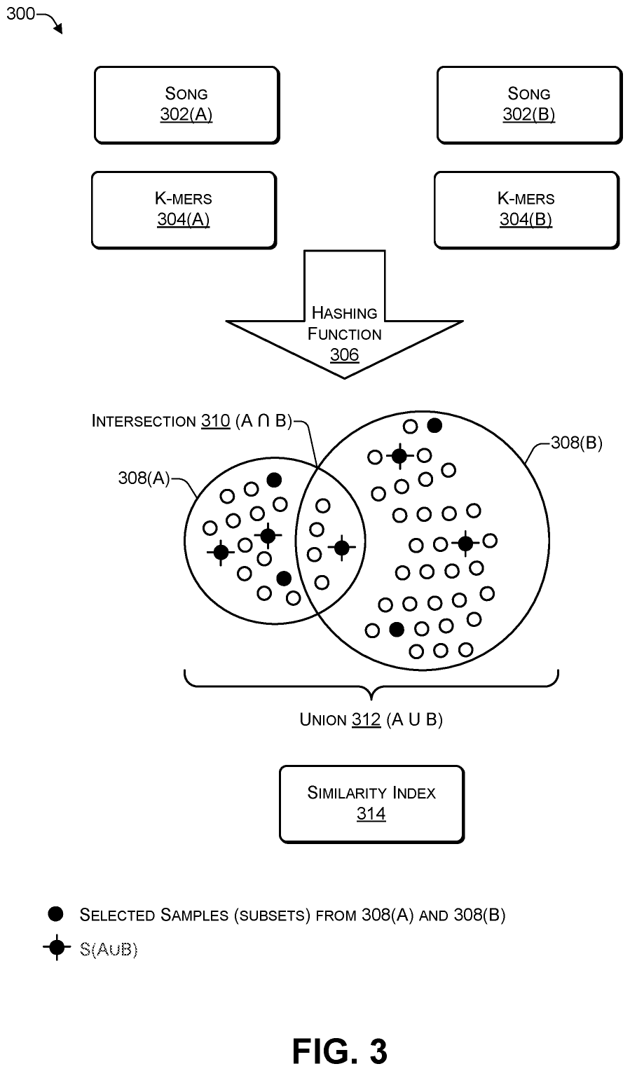

FIG. 3 is a block diagram 300 illustrating using a subset (sample) from two sets to determine similarities, according to some embodiments. To reduce the use of computational resources, the copyright checker 105 of FIG. 1 uses the following approach. A hashing algorithm J, such as the MinHash algorithm (e.g., min-wise independent permutations locality sensitive hashing scheme) or similar algorithm, is used to rapidly estimate a similarity between two sets A and B:

$$J ( A , B ) = \frac{\vert A ⋂ B \vert}{\vert A ⋃ B \vert} \approx \frac{\vert S ( A ⋃ B ) ⋂ S ( A ) ⋂ S ( B ) \vert}{\vert S ( A ⋃ B ) \vert}$$

The MinHash bottom sketch strategy may be used by the copyright checker 105 because it is an efficient approach to estimating the Jaccard similarity index between two sets, such as between two musical sequences. The sequences in each of the tracks of two songs 302(A) and 302(B) are broken down into their k-mer constituents, k-mers 304(A) and k-mers 304(B). A hashing function 306 is used to hash individual k-mers of the k-mers 304(A), 304(B), yielding either a 32-or 64-bit hash output contingent upon the size of the input k-mer. This process of hashing the k-mers 304(A), 304(B) results in two sets of hash values, 308(A) and 308(B), with each comprising |A| and |B| distinct hash values, respectively, depicted as small circles in FIG. 3.

A similarity index 314, such as the Jaccard index, may be determined based on a proportion (e.g., ratio) of (1) an intersection 310 of 308(A) and 308(B) relative to (2) a total number of unique hashes present in both A and B, e.g., union 312 of 308(A) and 308(B). To reduce the computational intensity, the MinHash algorithm uses a smaller approximation of 308(A) and 308(B) by selecting a smaller, random subset (referred to as a sketch) from the union 312 of 308(A) and 308(B). The copyright checker 105 creates MinHash sketches S(A) and S(B) (in this example, each has a size=5) that include the five minimal hash values from sets 308(A) and 308(B), respectively, as indicated by the filled small circles in FIG. 3. The use of S(A) and S(B) enables identifying five minimal hash values across the combined set A∪B (marked by crossed circles), denoted as S(A∪B). Thus, because S(A∪B)represents a random subset of A∪B, the ratio of shared elements between S(A) and S(B) within this subset serves as an unbiased estimator for the Jaccard similarity index J(A,B), thereby providing a computationally efficient way of estimating set similarity. The Jaccard index is defined as the ratio of(1) the number of elements of the intersection 310 to (2) the number of elements in the union 312. Of course, other measures of similarity besides Jaccard similarity, such as, for example, a simple matching coefficient, a Hamming distance, a Sorensen-Dice coefficient, a Tversky index, or a Tanimoto distance, or other similarity measurement may be used. The Jaccard similarity index is 0 when the two sets A and B are completely disjoint, 1 when the two sets are identical, and between 0 and 1 when there is similarity between the two sets. Two sets are more similar (e.g., have relatively more members in common) when their Jaccard index is closer to 1. The hashing algorithm (e.g., MinHash) is used to quickly estimate the similarity index 314 (e.g., J (A,B)), without computing the intersection and union of both sets in their entirety. In this way, the systems and techniques enable the comparison of a song to copyrighted songs in near real time, resulting in the detection of potential copyright infringement matches in less than 3 seconds.

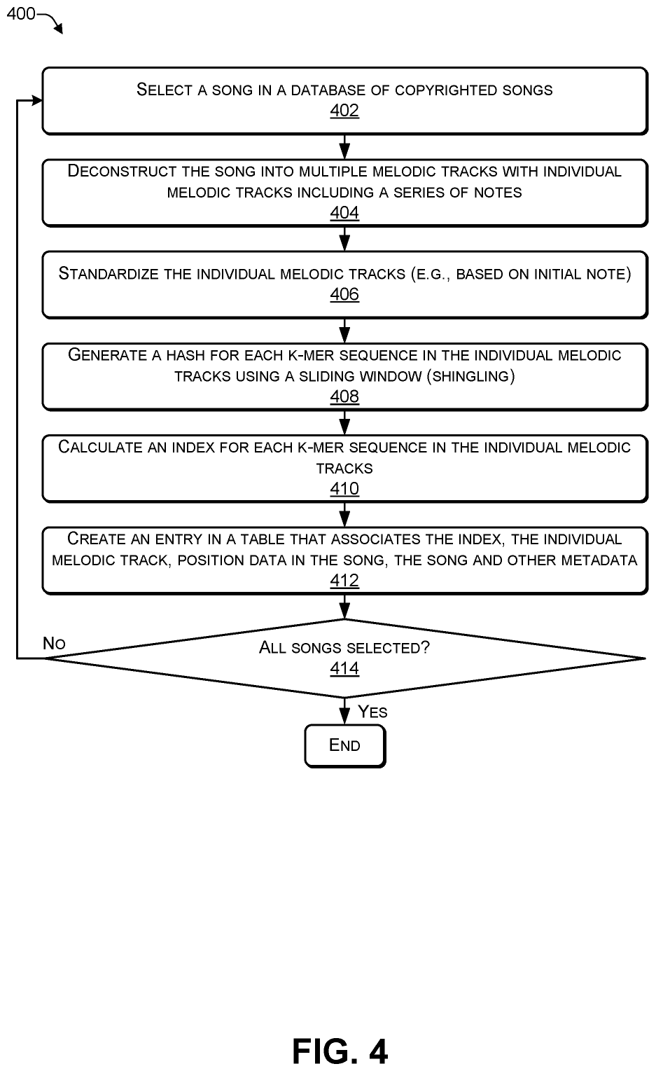

In the flow diagrams of FIGS. 4, 5, and 6 each block represents one or more operations that can be implemented in hardware, software, or a combination thereof. In the context of software, the blocks represent computer-executable instructions that, when executed by one or more processors, cause the processors to perform the recited operations. Generally, computer-executable instructions include routines, programs, objects, modules, components, data structures, and the like that perform particular functions or implement particular abstract data types. The order in which the blocks are described is not intended to be construed as a limitation, and any number of the described operations can be combined in any order and/or in parallel to implement the processes. For discussion purposes, the processes 400, 500, and 600 are described with reference to FIGS. 1, 2, and 3 as described above, although other models, frameworks, systems and environments may be used to implement these processes.

FIG. 4 is a flowchart of a process 400 to create a table of data associated with copyrighted songs, according to some embodiments. The process 400 may be performed by the copyright checker 105 of FIG. 1.

At 402, the process may select a song in a database of copyrighted songs. At 404, the song may be deconstructed into multiple melodic tracks with individual melodic track including a series of notes. At 406, the individual melodic tracks may be standardized (e.g., based on an initial note). For example, in FIG. 1, the copyright checker 105 may select one of the songs 120 in the database 118 and deconstruct the song 120 into the melodic tracks 122. The copyright checker 105 may use a standardization module 132 standardized the tracks 122 based on a first note in the melodic sequence, thereby retaining the relationship between the notes while making the notes key agnostic.

At 408, the process may generate a hash for each k-mer sequence in the individual melodic tracks using a sliding window (shingling). At 410, the process may calculate an index (hash) for each k-mer sequence in the individual melodic tracks. For example, in FIG. 2, the copyright checker 105 may calculate, using the hashing algorithm 128 of FIG. 1, the hash 210 for each sequence of notes 208 (k-mer, where k=8 in this example).

At 412, the process may create an entry in a table that associates the index, the individual melodic track, positional data in the song, the song, and other metadata. At 414, the process determines whether all of the songs in the database have been selected. If the process determines, at 414, that all the songs in the database have not been selected, then the process proceeds back to 402 to select a next song. In this way, the process may repeat 402, 404, 406, 408, 410, and 412 until all the songs have been selected and processed. If the process determines, at 414 that all songs in the database have been selected, then the process ends. For example, the copyright checker 105 creates the table 126, with each entry in the table 126 including the hash and associated metadata for each note sequence (k-mer) in each of the tracks 122 of the songs 120 in the database 118.

Thus, by creating hashes of each note sequence of each track and each song, each copyrighted song in the database is represented by a set of hashes. To determine whether a new song potentially has one or more tracks that are similar to a copyrighted song, the new song is deconstructed into multiple tracks, and hashes are created for note sequences in each of the multiple tracks to create a set of hashes. A similarity index is calculated using a subset of the hashes of the new song and a subset of the hashes of each of the copyrighted songs. For example, a ratio of (1) the intersection of the two subsets to (2) the union of the two subsets may be determined. The ratio results in a fraction between 0.0 and 1.0, with fractions closer to 1.0 indicating a greater possibility of infringement and factions closer to 0.0 indicating a small possibility of infringement. The ratio may be multiplied by 100 to provide a percentage similarity. For example, if the ratio is 0.75, then multiplying by 100 provides a 75% probability of similarity. The computational load to perform a comparison of two subsets of the hashes is significantly less then performing a comparison of the two full sets of hashes, thereby enabling the comparison of the subset of hashes of the new song with the subset of hashes of each of the songs in the database to be performed within a few seconds, thereby providing potential copyright infringement information substantially in real time.

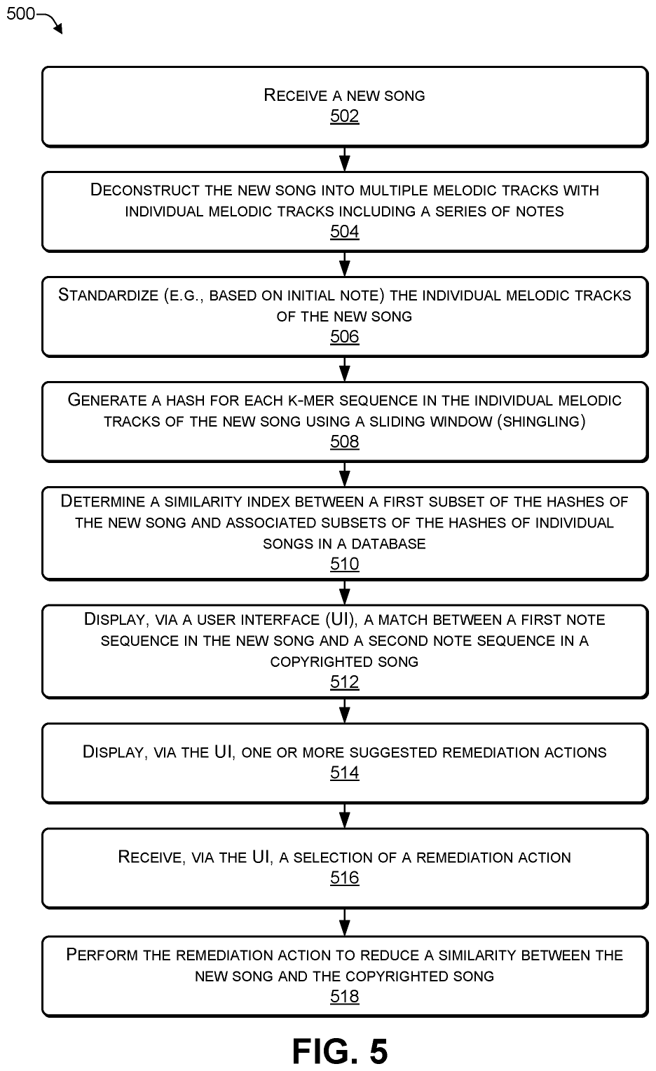

FIG. 5 is a flowchart of a process 500 that includes detecting similarities between a new song and a copyrighted song, according to some embodiments. The process 500 may be performed by the copyright checker 105 of FIG. 1.

At 502, the process may receive a new song. For example, in FIG. 1, the new song may be included in the output 110 produced by the generative AI 108, created using a DAW executing on the computing device 102, or any combination thereof (e.g., some of the tracks may be created by the generative AI 108 while other tracks may be created by a user using the DAW).

At 504, the process may deconstruct the new song into multiple melodic tracks with individual melodic tracks including a series of notes. At 506, the individual melodic tracks of the new song may be standardized (e.g., based on an initial note of each track). For example, in FIG. 2, the song file 202 may be deconstructed into the tracks 206 and each track standardized using the standardization module 130.

At 508, the process may generate a hash for each k-mer sequence in the individual melodic tracks of the new song using a sliding window (shingling). For example, in FIG. 2, the process may generate the hashes 210 based on the individual note sequences (k-mers) of each track 206.

At 510, the process may determine a similarity index between a first subset of the hashes of the new song and associated subsets of the hashes of individual songs in a database. For example, in FIG. 3, the copyright checker 105 of FIG. 1 may determine the similarity index 314 using a subset of 308(A) and a subset of 308(B) (the filled in circles in FIG. 3).

At 512, the process may display, via a user interface, a match between a first note sequence in the new song and a second note sequence in a copyrighted song. At 514, the process may display, via the UI, one or more suggested remediation actions. At 516, the process may receive, via the UI, a selection of a remediation action. At 518, the process may perform the remediation action to reduce a similarity between the new song and the copyrighted song. For example, in FIG. 1, the UI 136 may display the similar songs 138 in a particular order, such as from the most similar song to the least similar song. When a particular one of the similar songs is selected, the UI 136 may display the tracks in the song and, within each track, the similar sequence(s). The UI 136 may display the remediation actions 156, including enabling the user to modify a particular note sequence using the modify 160 or enabling the user to regenerate a track using the generative AI 108. Performing one or more of the remediation actions 156 may result in the new song being less similar to the copyrighted songs 120 in the database 118.

Thus, hashes of each note sequence of each track in each copyrighted song are created resulting in each copyrighted song having a representation in the form of a set of hashes. To determine whether a new song potentially has one or more tracks that are similar to a copyrighted song, the new song is deconstructed into multiple tracks, and hashes are created for note sequences (k-mers) in each of the multiple tracks to create a set of hashes. A similarity index is calculated using a subset of the hashes of the new song and a subset of the hashes of each of the copyrighted songs. For example, a ratio of (1) the intersection of the two subsets to (2) the union of the two subsets may be determined. The ratio results in a fraction between 0.0 and 1.0, with fractions closer to 1.0 indicating a greater possibility of infringement and factions closer to 0.0 indicating a small possibility of infringement. The ratio may be multiplied by 100 to provide a percentage similarity. The comparison of the subset of hashes of the new song with the subset of hashes of each of the songs in the database to be performed within a few seconds, thereby providing potential copyright infringement information substantially in real time. A UI may enable a user to remediate the similarities in the new song to reduce potential similarities and reduce the possibility of copyright infringement.

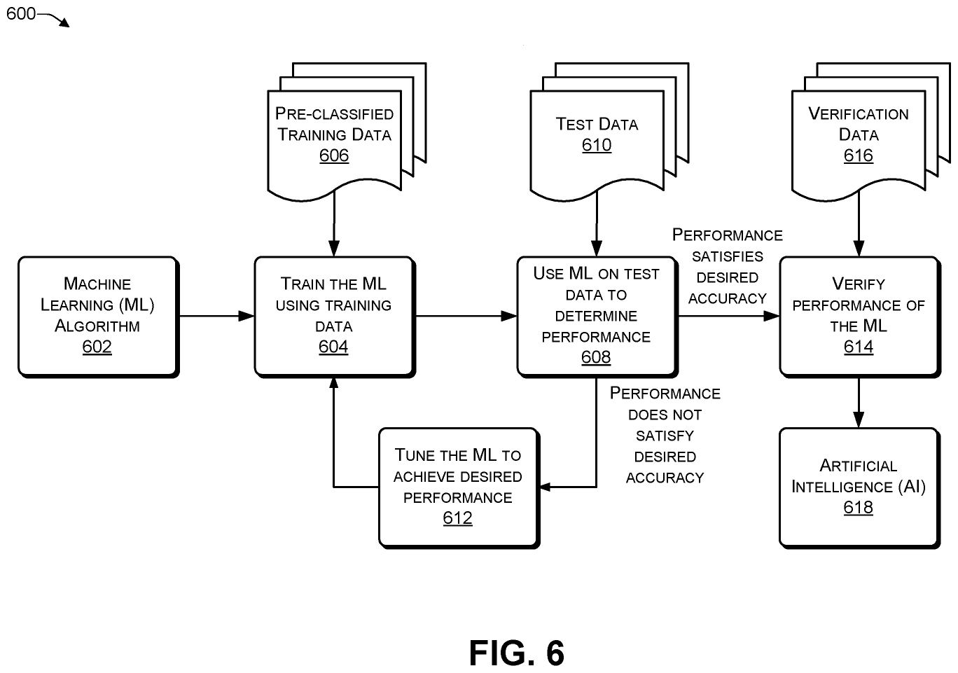

FIG. 6 is a flowchart of a process 600 to train (or retrain) a machine learning algorithm to create an artificial intelligence, according to some embodiments. For example, the process 600 may be performed during a training phase to train the generative AI 108.

At 602, a machine learning algorithm (e.g., software code) may be created by one or more software designers. At 604, the machine learning algorithm may be trained (e.g., fine-tuned) using pre-classified training data 606. For example, the training data 606 may have been pre-classified by humans, by machine learning, or a combination of both. After the machine learning algorithm has been trained using the pre-classified training data 606, the machine learning may be tested, at 608, using test data 610 to determine a performance metric of the machine learning. The performance metric may include, for example, precision, recall, Frechet Inception Distance (FID), or a more complex performance metric. For example, in the case of a classifier, the accuracy of the classification may be determined using the test data 610.

If the performance metric of the machine learning does not satisfy a desired measurement (e.g., 95%, 98%, 99% in the case of accuracy), at 608, then the machine learning code may be tuned, at 612, to achieve the desired performance measurement. For example, at 612, the software designers may modify the machine learning software code to improve the performance of the machine learning algorithm. After the machine learning has been tuned, at 612, the machine learning may be retrained, at 604, using the pre-classified training data 606. In this way, 604, 608, 612 may be repeated until the performance of the machine learning is able to satisfy the desired performance metric. For example, in the case of a classifier, the classifier may be tuned to classify the test data 610 with the desired accuracy.

After determining, at 608, that the performance of the machine learning satisfies the desired performance metric, the process may proceed to 614, where verification data 616 may be used to verify the performance of the machine learning. After the performance of the machine learning is verified, at 614, the machine learning 602, which has been trained to provide a particular level of performance may be used as an artificial intelligence (AI) 618. For example, the AI 618 may be any type of AI described herein, such as the generative AI 108 of FIG. 1.

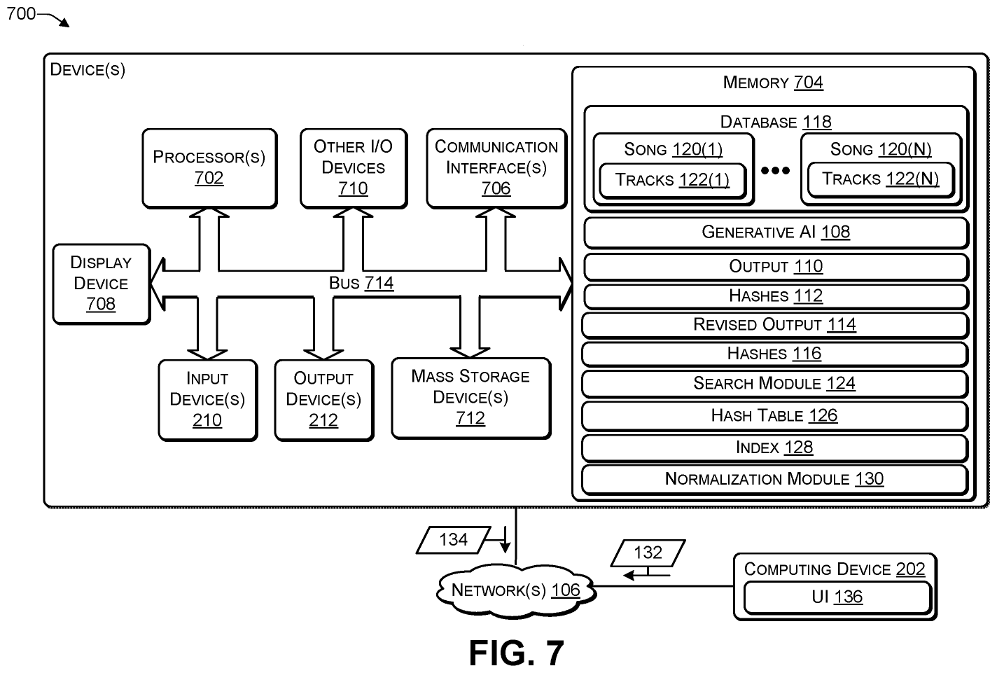

FIG. 7 illustrates an example configuration of a device 700 that can be used to implement the systems and techniques described herein, such as for example, the server 104 and/or the computing device 102. For illustration purposes, the device 700 is shown as implementing the server 104.

The device 700 may include one or more processors 702 (e.g., CPU, GPU, or the like), a memory 704, communication interfaces 706, a display device 708, other input/output (I/O) devices 710 (e.g., keyboard, trackball, and the like), and one or more mass storage devices 712 (e.g., disk drive, solid state disk drive, or the like), configured to communicate with each other, such as via one or more system buses 714 or other suitable connections. While a single system bus 714 is illustrated for ease of understanding, it should be understood that the system buses 714 may include multiple buses, such as a memory device bus, a storage device bus (e.g., serial ATA (SATA) and the like), data buses (e.g., universal serial bus (USB) and the like), video signal buses (e.g., ThunderBolt®, DVI, HDMI, and the like), power buses, etc.

The processors 702 are one or more hardware devices that may include a single processing unit or a number of processing units, all of which may include single or multiple computing units or multiple cores. The processors 702 may include a graphics processing unit (GPU) that is integrated into the CPU or the GPU may be a separate processor device from the CPU. The processors 702 may be implemented as one or more microprocessors, microcomputers, microcontrollers, digital signal processors, central processing units, graphics processing units, state machines, logic circuitries, and/or any devices that manipulate signals based on operational instructions. Among other capabilities, the processors 702 may be configured to fetch and execute computer-readable instructions stored in the memory 704, mass storage devices 712, or other computer-readable media.

Memory 704 and mass storage devices 712 are examples of computer storage media (e.g., memory storage devices) for storing instructions that can be executed by the processors 702 to perform the various functions described herein. For example, memory 704 may include both volatile memory and non-volatile memory (e.g., random access memory (RAM), read only memory (ROM), or the like) devices. Further, mass storage devices 712 may include hard disk drives, solid-state drives, removable media, including external and removable drives, memory cards, flash memory, floppy disks, optical disks (e.g., compact disc (CD), digital versatile disc (DVD), a storage array, a network attached storage (NAS), a storage area network (SAN), or the like. Both memory 704 and mass storage devices 712 may be collectively referred to as memory or computer storage media herein and may be any type of non-transitory media capable of storing computer-readable, processor-executable program instructions as computer program code that can be executed by the processors 702 as a particular machine configured for carrying out the operations and functions described in the implementations herein.

The device 700 may include one or more communication interfaces 706 for exchanging data via the network 110. The communication interfaces 706 can facilitate communications within a wide variety of networks and protocol types, including wired networks (e.g., Ethernet, Data Over Cable Service Interface Specification (DOCSIS), digital subscriber line (DSL), Fiber, universal serial bus (USB) etc.) and wireless networks (e.g., wireless local area network (WLAN), global system for mobile (GSM), code division multiple access (CDMA), 802.11, Bluetooth, Wireless USB, ZigBee, cellular, satellite, etc.), the Internet and the like. Communication interfaces 706 can also provide communication with external storage, such as a storage array, network attached storage, storage area network, cloud storage, or the like.

The display device 708 and the output devices 212 (e.g., virtual reality (VR) headset) may be used for displaying content (e.g., information and images) to users. Other I/O devices 710 and the input devices 210 may be devices that receive various inputs from a user and provide various outputs to the user, and may include a keyboard, a touchpad, a mouse, a gaming controller (e.g., joystick, steering controller, accelerator pedal, brake pedal controller, VR headset, VR glove, or the like), a printer, audio input/output devices, and so forth.

The computer storage media, such as memory 116 and mass storage devices 712, may be used to store software and data, as illustrated in FIG. 7.

The example systems and computing devices described herein are merely examples suitable for some implementations and are not intended to suggest any limitation as to the scope of use or functionality of the environments, architectures and frameworks that can implement the processes, components and features described herein. Thus, implementations herein are operational with numerous environments or architectures, and may be implemented in general purpose and special-purpose computing systems, or other devices having processing capability. Generally, any of the functions described with reference to the figures can be implemented using software, hardware (e.g., fixed logic circuitry) or a combination of these implementations. The term “module,” “mechanism” or “component” as used herein generally represents software, hardware, or a combination of software and hardware that can be configured to implement prescribed functions. For instance, in the case of a software implementation, the term “module,” “mechanism” or “component” can represent program code (and/or declarative-type instructions) that performs specified tasks or operations when executed on a processing device or devices (e.g., CPUs or processors). The program code can be stored in one or more computer-readable memory devices or other computer storage devices. Thus, the processes, components and modules described herein may be implemented by a computer program product.

Furthermore, this disclosure provides various example implementations, as described and as illustrated in the drawings. However, this disclosure is not limited to the implementations described and illustrated herein, but can extend to other implementations, as would be known or as would become known to those skilled in the art. Reference in the specification to “one implementation,” “this implementation,” “these implementations” or “some implementations” means that a particular feature, structure, or characteristic described is included in at least one implementation, and the appearances of these phrases in various places in the specification are not necessarily all referring to the same implementation.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method comprising:
receiving, by one or more processors, a new song comprised of multiple tracks;
creating, by the one or more processors, a first set of hashes based on the multiple tracks;
selecting, by the one or more processors, data associated with a copyrighted song in a database, the data including a second set of hashes associated with the copyrighted song;
performing a comparison, by the one or more processors, of
a first subset of the first set of hashes to
a second subset of the second set of hashes;
determining, by the one or more processors and based on the comparison, a similarity index;
indicating, by the one or more processors, a similarity between the new song and the copyrighted song based on the similarity index;
receiving, by the one or more processors, a selection to modify the new song to reduce the similarity between the new song and the copyrighted song; and
modifying, by the one or more processors, the new song to reduce the similarity between the new song and the copyrighted song.

2. The method of claim 1, further comprising:
generating, by a generative artificial intelligence, at least one track of the multiple tracks of the new song.

3. The method of claim 1, wherein creating the first set of hashes based on the multiple tracks comprises:
deconstructing the new song into the multiple tracks;
selecting a particular track of the multiple tracks; and
creating, for the particular track of the multiple tracks, a hash for individual note sequences included in the particular track.

4. The method of claim 3, wherein individual note sequences included in the particular track comprise at least 8 consecutive notes.

5. The method of claim 1, wherein:
the similarity index comprises a Jaccard index.

6. The method of claim 1, wherein performing a comparison of a first subset of the first set of hashes to a second subset of the second set of hashes comprises:
determining an intersection of the first subset of the first set of hashes and the second subset of the second set of hashes;
determining a union of the first subset of the first set of hashes and the second subset of the second set of hashes; and
determining a ratio of the intersection to the union.

7. A server comprising:
one or more processors;
a non-transitory memory device to store instructions executable by the one or more processors to perform operations comprising:
receiving a new song comprised of multiple tracks;
creating a first set of hashes based on the multiple tracks;
selecting data associated with a copyrighted song in a database, the data including a second set of hashes associated with the copyrighted song;
performing a comparison of
a first subset of the first set of hashes to a second subset of the second set of hashes;
determining, based on the comparison, a similarity index;
indicating a similarity between the new song and the copyrighted song based on the similarity index;
receiving a selection to modify the new song to reduce the similarity between the new song and the copyrighted song; and
modifying the new song to reduce the similarity between the new song and the copyrighted song.

8. The server of claim 7, further comprising:
generating, by a generative artificial intelligence, each track of the multiple tracks of the new song.

9. The server of claim 7, wherein creating the first set of hashes based on the multiple tracks comprises:
deconstructing the new song into the multiple tracks;
selecting a particular track of the multiple tracks; and
creating, for the particular track of the multiple tracks, a hash for individual note sequences included in the particular track, the individual note sequences comprising at least 8 consecutive notes.

10. The server of claim 7, wherein:
the similarity index comprises a Jaccard index.

11. The server of claim 7, wherein performing the comparison of the first subset of the first set of hashes to the second subset of the second set of hashes comprises:
determining an intersection of the first subset of the first set of hashes and the second subset of the second set of hashes;
determining a union of the first subset of the first set of hashes and the second subset of the second set of hashes; and
determining a ratio of the intersection to the union.

12. The server of claim 7, wherein modifying the new song to reduce the similarity between the new song and the copyrighted song comprises:
determining that a particular track of the multiple tracks of the new song is similar to a copyrighted track of the copyrighted song; and
automatically modifying one or more note sequences in the particular track, the modifying including:
adding one or more notes in the particular track;
deleting one or more notes in the particular track;
modifying a pitch of one or more notes in the particular track;
modifying a duration of one or more notes in the particular track; or any combination thereof.

13. The server of claim 7, wherein modifying the new song to reduce the similarity between the new song and the copyrighted song comprises:
determining that a particular track of the multiple tracks of the new song is similar to a copyrighted track of the copyrighted song; and
instructing a generative artificial intelligence to generate a new track to replace the particular track.

14. A non-transitory computer-readable memory device to store instructions executable by one or more processors to perform operations comprising:
receiving a new song comprised of multiple tracks;
creating a first set of hashes based on the multiple tracks;
selecting data associated with a copyrighted song in a database, the data including a second set of hashes associated with the copyrighted song;
performing a comparison of
a first subset of the first set of hashes to a second subset of the second set of hashes;
determining, based on the comparison, a similarity index;
indicating a similarity between the new song and the copyrighted song based on the similarity index;
receiving a selection to modify the new song to reduce the similarity between the new song and the copyrighted song; and
modifying the new song to reduce the similarity between the new song and the copyrighted song.

15. The non-transitory computer-readable memory device of claim 14, the operations further comprising:
generating, by a generative artificial intelligence, each track of the multiple tracks of the new song.

16. The non-transitory computer-readable memory device of claim 14, wherein creating the first set of hashes based on the multiple tracks comprises:
deconstructing the new song into the multiple tracks;
selecting a particular track of the multiple tracks; and
creating, for the particular track of the multiple tracks, a hash for individual note sequences included in the particular track, the individual note sequences comprising at least 8 consecutive notes.

17. The non-transitory computer-readable memory device of claim 14, wherein:
the similarity index comprises a Jaccard index.

18. The non-transitory computer-readable memory device of claim 14, wherein performing the comparison of the first subset of the first set of hashes to the second subset of the second set of hashes comprises:
determining an intersection of the first subset of the first set of hashes and the second subset of the second set of hashes;
determining a union of the first subset of the first set of hashes and the second subset of the second set of hashes; and
determining a ratio of the intersection to the union.

19. The non-transitory computer-readable memory device of claim 14, wherein modifying the new song to reduce the similarity between the new song and the copyrighted song comprises:
determining that a particular track of the multiple tracks of the new song is similar to a copyrighted track of the copyrighted song; and
automatically modifying one or more note sequences in the particular track, the modifying including:
adding one or more notes in the particular track;
deleting one or more notes in the particular track;
modifying a pitch of one or more notes in the particular track;
modifying a duration of one or more notes in the particular track; or any combination thereof.

20. The non-transitory computer-readable memory device of claim 14, wherein modifying the new song to reduce the similarity between the new song and the copyrighted song comprises:
determining that a particular track of the multiple tracks of the new song is similar to a copyrighted track of the copyrighted song; and
instructing a generative artificial intelligence to generate a new track to replace the particular track.
